(19) United States
(12) Patent Application Publication
(10) Pub. No.: US 2008/0283398 A1
(43) Pub. Date: Nov. 20, 2008

(54) SOOT SENSING SYSTEMS HAVING SOOT SENSORS AND METHODS FOR MANUFACTURING THE SOOT SENSORS

(76) Inventors: Charles Scott Nelson, Fenton, MI (US); Kaius K. Polikarpus, Grand Blanc, MI (US); Walter T. Symons, Grand Blanc, MI (US)

Correspondence Address: DELPHI TECHNOLOGIES, INC., M/C 480-410-202, PO BOX 5052, TROY, MI, 48007, US

(21) Appl. No.: 11/749,262

(22) Filed: May 16, 2007

(51) Int. Cl. G01N 27/26

(52) U.S. Cl. 204/406; 204/433

(57) ABSTRACT

Soot sensing systems and soot sensors are provided. In one exemplary embodiment, a soot sensor includes a non-conductive substrate and a first electrode disposed on the non-conductive substrate. The soot sensor further includes a second electrode disposed on the non-conductive substrate and spaced away from the first electrode. The soot sensor further includes a first protective layer disposed over at least a portion of the first electrode. The soot sensor further includes a second protective layer disposed over at least a portion of the second electrode. Further, an electrical parameter between the first and second electrodes is indicative of an amount of soot disposed on the non-conductive substrate between the first and second electrodes.

### BACKGROUND

This application relates to soot sensing systems having soot sensors and methods for manufacturing the soot sensors.

Soot sensors have been developed that have metal electrodes that are exposed to an exhaust stream. A problem with these soot sensors is that the impingement of the exhaust gases on the metal electrodes will erode away the electrodes over time. As a result, the soot sensors can have impaired or degraded operation over time due to the erosion of the metal electrodes.

Accordingly, the inventors herein have recognized a need for an improved soot sensing system having a soot sensor that reduces and/or eliminates the foregoing deficiencies.

### SUMMARY OF THE INVENTION

A soot sensor in accordance with an exemplary embodiment is provided. The soot sensor includes a non-conductive substrate and a first electrode disposed on the non-conductive substrate. The soot sensor further includes a second electrode disposed on the non-conductive substrate and spaced away from the first electrode. The soot sensor further includes a first protective layer disposed over at least a portion of the first electrode. The soot sensor further includes a second protective layer disposed over at least a portion of the second electrode. Further, an electrical parameter between the first and second electrodes is indicative of an amount of soot disposed on the non-conductive substrate between the first and second electrodes.

A soot sensing system in accordance with another exemplary embodiment is provided. The soot sensing system includes a soot sensor having a non-conductive substrate, first and second electrodes, and first and second protective layer layers. The first electrode is disposed on the non-conductive substrate. The second electrode is disposed on the non-conductive substrate and spaced away from the first electrode. The first protective layer is disposed over at least a portion of the first electrode. The second protective layer is disposed over at least a portion of the second electrode. Further, an electrical parameter between the first and second electrodes is indicative of an amount of soot disposed on the non-conductive substrate between the first and second electrodes. The soot sensing system further includes a measuring circuit electrically coupled to the first and second electrodes. The measuring circuit is configured to generate a signal indicative of the electrical parameter and further indicative of the amount of soot disposed on the non-conductive substrate between the first and second electrodes.

A method for manufacturing a soot sensor in accordance with another exemplary embodiment is provided. The method includes disposing a first electrode on a non-conductive substrate. The method further includes disposing a second electrode on the non-conductive substrate and spaced away from the first electrode. The method further includes disposing a first protective layer over at least a portion of the first electrode. The method further includes disposing a second protective layer over at least a portion of the second electrode. Further, an electrical parameter between the first and second electrodes is indicative of an amount of soot disposed on the non-conductive substrate between the first and second electrodes.

A soot sensor in accordance with another exemplary embodiment is provided. The soot sensor includes a non-conductive substrate and a first electrode disposed on the non-conductive substrate. The first electrode has a first metal portion and a first metal oxide portion coupled to the first metal portion. The soot sensor further includes a second electrode disposed on the non-conductive substrate and spaced away from the first electrode. The second electrode has a second metal portion and a second metal oxide portion coupled to the second metal portion. Further, an electrical parameter between the first and second electrodes is indicative of an amount of soot disposed on the non-conductive substrate between the first and second electrodes.

A soot sensing system in accordance with another exemplary embodiment is provided. The soot sensing system includes a soot sensor having a non-conductive substrate and first and second electrodes. The first electrode is disposed on the non-conductive substrate. The first electrode has a first metal portion and a first metal oxide portion coupled to the first metal portion. The second electrode is disposed on the non-conductive substrate and spaced away from the first electrode. The second electrode has a second metal portion and a second metal oxide portion coupled to the second metal portion. An electrical parameter between the first and second electrodes is indicative of an amount of soot disposed on the non-conductive substrate between the first and second electrodes. The soot sensing system further includes a measuring circuit electrically coupled to the first and second electrodes. The measuring circuit is configured to generate a signal indicative of the electrical parameter and further indicative of the amount of soot disposed on the non-conductive substrate between the first and second electrodes.

A method for manufacturing a soot sensor in accordance with another exemplary embodiment is provided. The method includes disposing first electrode on the non-conductive substrate. The first electrode has a first metal portion and a first metal oxide portion coupled to the first metal portion. The method further includes disposing a second electrode on the non-conductive substrate and spaced away from the first electrode. The second electrode has a second metal portion and a second metal oxide portion coupled to the second metal portion. Further, an electrical parameter between the first and second electrodes is indicative of an amount of soot disposed on the non-conductive substrate between the first and second electrodes.

### BRIEF DESCRIPTION OF THE DRAWINGS

FIG. 1 is a block diagram of a soot sensing system in accordance with an exemplary embodiment;

FIG. 2 is a schematic of a soot sensor utilized in the soot sensing system of FIG. 1;

FIG. 3 is a graph of a curve illustrating a relationship between a resistivity level associated with the soot sensor of FIG. 2 and an amount of soot deposited on the soot sensor;

FIG. 4 is a flowchart of a method for manufacturing the soot sensor of FIG. 2;

FIG. 5 is a schematic of another soot sensor that can be utilized in the soot sensing system of FIG. 1 in accordance with another exemplary embodiment;

FIG. 6 is a schematic of another soot sensor that can be utilized in the soot sensing system of FIG. 1 in accordance with another exemplary embodiment;

FIG. 7 is a flowchart of a method for manufacturing the soot sensor of FIG. 6; and

FIG. 8 is a block diagram of a deposition machine that can be utilized to manufacture the soot sensors in FIGS. 2, 5 and 6.

### DESCRIPTION OF EXEMPLARY EMBODIMENTS

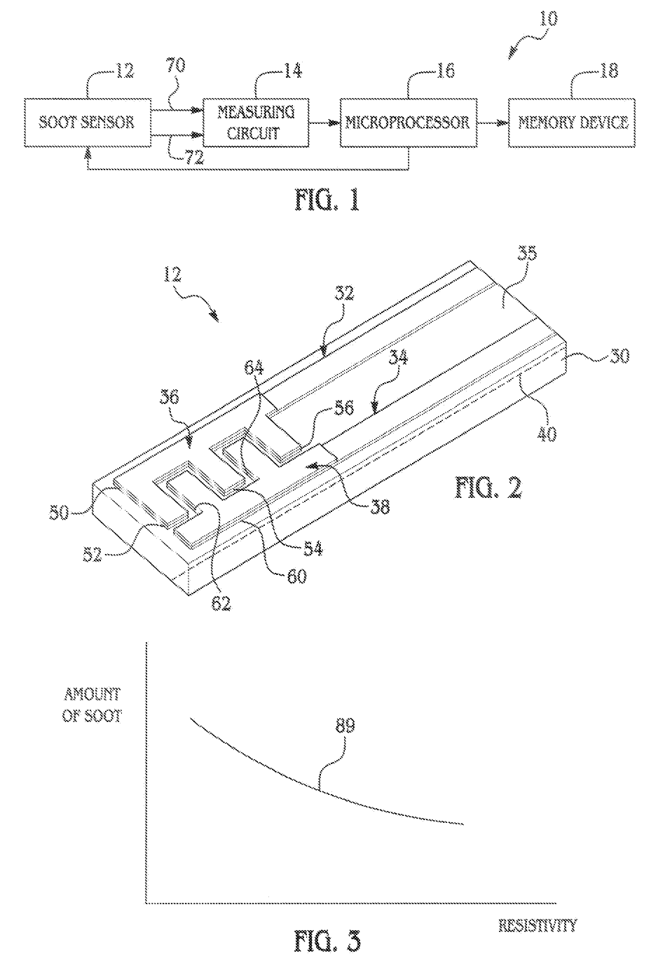

Referring to FIGS. 1 and 2, a soot sensing system 10 for detecting an amount of soot in an exhaust stream is illustrated. The soot sensing system 10 includes a soot sensor 12, a measuring circuit 14, a microprocessor 16, and a memory device 18.

The soot sensor 12 is provided to detect an amount of soot in an exhaust stream communicating with the soot sensor 12. The soot sensor 12 includes a nonconductive substrate 30, electrodes 32, 34, protective layers 36, 38 and a heater 40.

The nonconductive substrate 30 has a generally rectangular shape. Of course in alternative embodiments, the nonconductive substrate 30 could have alternate shapes known to those skilled in the art. The nonconductive substrate 30 is constructed from an electrically nonconductive material. For example, in one exemplary embodiment the nonconductive substrate 30 is constructed from alumina. Of course in alternative embodiments, the nonconductive substrate 30 could be constructed from other electrically nonconductive materials known to those skilled in the art.

The electrode 32 is disposed on a surface 35 of the nonconductive substrate 30. The electrode 32 includes a body portion 50 and finger portions 52, 54, 56. The electrode 32 is constructed from an electrically conductive material. For example, in one exemplary embodiment, the electrode 32 is constructed from a platinum layer deposited on the surface 35. Of course, in alternative embodiments the electrode 32 could be constructed from other electrically conductive metallic materials known to those skilled in the art, such as gold, silver, copper, or combinations thereof for example. The body portion 50 has a generally rectangular shape extending longitudinally along the surface 35. The finger portions 52, 54, 56 are generally rectangular shaped and extend from the body portion 50 generally parallel to one another and spaced apart from one another.

The electrode 34 is disposed on the surface 35 of the nonconductive substrate 30 and is spaced apart from the electrode 32. The electrode 34 includes a body portion 60 and finger portions 62, 64. The electrode 34 is constructed from an electrically conductive material. For example, in one exemplary embodiment, the electrode 34 is constructed from a platinum layer deposited on the surface 35. Of course, in alternative embodiments the electrode 34 could be constructed from other electrically conductive materials known to those skilled in the art, such as gold, silver, copper, or combinations thereof for example. The body portion 60 has a generally rectangular shape extending longitudinally along the surface 35. The finger portions 62, 64 are generally rectangular shaped and extend from the body portion 60 generally parallel to one another and spaced apart from one another. The finger portions 62, 64 of the electrode 34 are interdigitated with the finger portions 52, 54, 56 of the electrode 32.

It should be noted that an electrical parameter between the electrodes 32, 34 can be utilized to determine an amount of soot that has been deposited on the soot sensor 12, which is further indicative of an amount of soot in an exhaust stream communicating with the sensor 12. In one exemplary embodiment, the electrical parameter between the electrodes 32, 34 that is utilized to determine the amount of soot deposited on the sensor 12 is a resistivity level between the electrodes 32, 34. It should be noted that when soot is deposited between the electrodes 32, 34, a relatively high resistance electrical short is obtained between the electrodes 32, 34. Thus, as additional soot is deposited on the sensor 12, a resistivity level between the electrodes 32, 34 is reduced. Accordingly, the resistivity level between the electrodes 32, 34 can be utilized to calculate the amount of soot that has been deposited on the sensor 12. Of course, in alternative embodiments other electrical parameters could be utilized to determine the amount of soot deposited on the sensor 12, such as conductivity level or a capacitance level between the electrodes 32, 34 for example.

The protective layer 36 is disposed over a portion of the electrode 32 to prevent exhaust gases from eroding away portions of the electrode 32. In particular, the protective layer 36 is disposed over the finger portions 52, 54, 56 and a portion of the body portion 50 coupled to the finger portions for 52, 54, 56. In one exemplary the embodiment, the protective layer 36 is a thin coating of a metal oxide (e.g., zirconia) having a thickness of in a range of 6-50 microns. In another exemplary embodiment, the protective layer 36 is a thin coating of zirconia having a thickness within a range of 6-12 microns. Of course in alternative embodiments, the protective layer 36 can be a thin coating of zirconia having a thickness within a range outside of 6-50 microns. Further, in alternative embodiments, the protective layer 36 could be constructed from other materials known to those skilled in the art, such as silicon carbide. It should be noted that the protective layer 36, constructed, from zirconia, can conduct an electrical current when the protective layer 36 is above a predetermined temperature, such as 100 degrees Celsius.

The protective layer 38 is disposed over a portion of the electrode 34 to prevent exhaust gases from eroding away portions of the electrode 34. In particular, the protective layer 38 is disposed over the finger portions 62, 64 and a portion of the body portion 60 coupled to the finger portions 62, 64. In one exemplary the embodiment, the protective layer 38 is a thin coating of a metal oxide (e.g., zirconia) having a thickness within a range of 6-50 microns. In another exemplary embodiment, the protective layer 38 is a thin coating of zirconia having a thickness within a range of 6-12 microns. Of course in alternative embodiments, the protective layer 38 can be a thin coating of zirconia having a thickness within a range outside of 6-50 microns. Further, in alternative embodiments, the protective layer 38 could be constructed from other materials known to those skilled in the art such as silicon carbide.

The heater 40 is disposed within the nonconductive substrate 30 and is provided to maintain the soot sensor 12 within the desired temperature range. In particular, the heater 40 generates heat in response to a signal received from the microprocessor 16. In one exemplary embodiment, the heater 40 maintains the nonconductive substrate 30 within a temperature range of 100-500 degrees Celsius when detecting an amount of soot on the soot sensor 12. The heater 40 can also periodically increase the temperature of the soot sensor 12 to at least 550 degrees Celsius to burn off the collected soot on the soot sensor 12. In one exemplary embodiment, the heater 40 is a metal trace disposed on the nonconductive substrate 30.

The measuring circuit 14 is provided to measure an electrical parameter between the electrodes 32, 34 of the soot sensor 12 that is indicative of an amount of soot deposited on the sensor 12. In one exemplary embodiment, the electrical parameter is a resistivity level between the electrodes 32, 34. As shown, the measuring circuit 14 is electrically coupled to the electrodes 32, 34 of the soot sensor 12, via the conductive lines 70, 72, respectively. Further, the measuring circuit 14 is electrically coupled to the microprocessor 16. During operation, the measuring circuit 14 applies a voltage between the electrodes 32, 34. In response to the applied voltage, an electrical current flows through the electrode 32, the protective layer 36, the soot deposited between the electrodes 32, 34, the protective layer 38, and the electrode 34 to the measuring circuit 14. The measuring circuit 14 generates a signal indicative of the resistivity level between the electrodes 32, 34, based on an amount of the electrical current. Further, the microprocessor 16 receives the signal from the measuring circuit 14.

The microprocessor 16 is provided to determine an amount of soot deposited on the soot sensor 12 based on a signal from the measuring circuit 14. In particular, when the microprocessor 16 receives the signal indicative of a resistance level between the electrodes 32, 34 from the measuring circuit 14, the microprocessor 16 calculates an amount of soot utilizing the following equation: amount of soot=f(resistivity level), where f corresponds to an arithmetic function. Referring to FIG. 3, a curve 89 illustrates a relationship between an amount of soot deposited on the sensor 12 and the resistivity level between the electrodes 32, 34. The microprocessor 16 is further configured to store a value indicative of the resistivity level between the electrodes 32, 34 in the memory device 18. The microprocessor 16 is further configured to generate a signal that is received by the heater 44 to maintain a temperature of the soot sensor 12 within a desired temperature range.

Referring to FIG. 4, a method for manufacturing the soot sensor 12 will now be explained.

At process step 90, the deposition machine 210 disposes of the electrode 32 on the non-conductive substrate 30.

At process step 92, the deposition machine 210 disposes the electrode 34 on the non-conductive substrate 30 which is spaced away from the electrode 32.

At process step 94, the deposition machine 210 disposes of the protective layer 36 over at least a portion of the electrode 32.

At process step 96, the deposition machine 210 disposes of the protective layer 38 over at least a portion of the electrode 34, such that an electrical parameter between the electrodes 32, 34 is indicative of an amount of soot disposed on the non-conductive substrate 30 between the electrodes 32, 34.

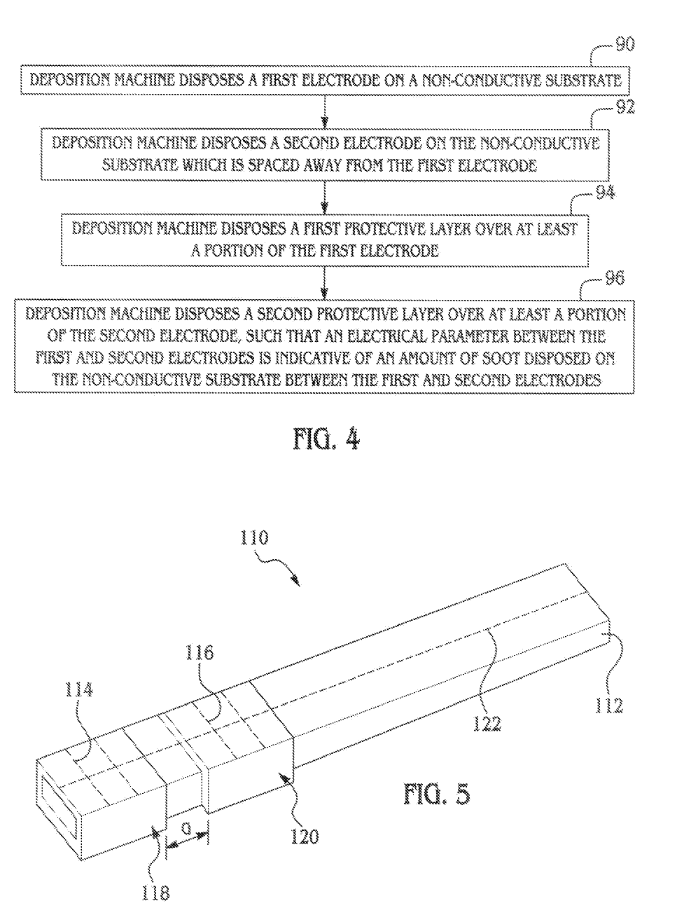

Referring to FIG. 5, a soot sensor 110 that can be utilized in the soot sensing system 110, instead of the soot sensor 12, will now be explained. The soot sensor 110 is provided to detect an amount of soot in an exhaust stream communicating with the soot sensor 110. The soot sensor 110 includes a nonconductive substrate 112, electrodes 114, 116, protective layers 118, 140 and a heater 122.

The nonconductive substrate 112 has a generally rectangular shape. Of course in alternative embodiments, the nonconductive substrate could have alternate shapes known to those skilled in the art. The nonconductive substrate 112 is constructed from an electrically nonconductive material. For example, in one exemplary embodiment the nonconductive substrate 112 is constructed from alumina. Of course in alternative embodiments, the nonconductive substrate 112 could be constructed from other electrically nonconductive materials known to those skilled in the art.

The electrode 114 is disposed on a surface of the nonconductive substrate 112. The electrode 114 is constructed from an electrically conductive material. For example, in one exemplary embodiment, the electrode 114 is constructed from a platinum layer deposited on the nonconductive substrate 112. Of course, in alternative embodiments the electrode 114 could be constructed from other electrically conductive materials known to those skilled in the art, such as gold, silver, copper, or combinations thereof for example. Further, in alternative embodiments, the electrode 114 can be disposed circumferentially around the nonconductive substrate 112.

The electrode 116 is disposed on a surface of the nonconductive substrate 112 and is spaced away from the electrode 114. The electrode 116 is constructed from an electrically conductive material. For example, in one exemplary embodiment, the electrode 116 is constructed from a platinum layer deposited on the nonconductive substrate 112. In another exemplary embodiment, the electrode 116 could extend circumferentially around the nonconductive substrate 112. Further, in alternative embodiments the electrode 116 could be constructed from other electrically conductive materials known to those skilled in the art, such as gold, silver, copper, or combinations thereof for example. Further, in alternative embodiments, the electrode 116 can be disposed circumferentially around the nonconductive substrate 112.

It should be noted that an electrical parameter between the electrodes 114, 116 can be utilized to determine an amount of soot that has been deposited on the soot sensor 110, which is further indicative of an amount of soot in an exhaust stream communicating with the sensor 110. In one exemplary embodiment, the electrical parameter between the electrodes 114, 116 that is utilized to determine an amount of soot deposited on the sensor 110 is a resistivity level between the electrodes 114, 116. It should be noted that when soot is deposited between the protective layers 118, 120, a relatively high resistance electrical short is obtained between the electrodes 114, 116. Thus, as additional soot is deposited on the sensor 110, a resistivity level between the electrodes 114, 116 is reduced. Accordingly, the resistivity level between the electrodes 114, 116 can be utilized to calculate the amount of soot that has been deposited on the sensor 110. Of course, in alternative embodiments other electrical parameters could be utilized to determine the amount of soot deposited on the sensor 110, such as conductivity level or a capacitance level between the electrodes 114, 116 for example.

The protective layer 118 is disposed circumferentially on the electrode 114 circumferentially around the nonconductive substrate 112 to prevent exhaust gases from eroding away portions of the electrode 114 and forms an electrode around the circumference of the substrate 112. In one exemplary the embodiment, the protective layer 118 is constructed from a thin coating of a metal oxide (e.g., zirconia) having a thickness within a range of 6-50 microns. In another exemplary embodiment, the protective layer 118 is a thin coating of zirconia having a thickness within a range of 6-12 microns. Of course in alternative embodiments, the protective layer 118 can be a thin coating of zirconia having a thickness within a range outside of 6-50 microns. Further, in alternative embodiments, the protective layer 118 could be constructed from other materials known to those skilled in the art such as silicon carbide. It should be noted that the protective layer 118, constructed from zirconia, can conduct an electrical current when the protective layer 118 is above a predetermined temperature, such as 100 degrees Celsius.

The protective layer 120 is disposed on the electrode 116 circumferentially around the nonconductive substrate 112 to prevent exhaust gases from eroding away portions of the electrode 116. In one exemplary the embodiment, the protective layer 120 is constructed from a thin coating of a metal oxide (e.g., zirconia) having a thickness within a range of 6-50 microns. In another exemplary embodiment, the protective layer 120 is a thin coating of zirconia having a thickness within a range of 6-12 microns. Of course in alternative embodiments, the protective layer 120 can be a thin coating of zirconia having a thickness within a range outside of 6-50 microns. Further, in alternative embodiments, the protective layer 120 could be constructed from other materials known to those skilled in the art such as silicon carbide. It should be noted that the protective layer 120, constructed from zirconia, can conduct an electrical current when the protective layer 120 is above a predetermined temperature, such as 100 degrees Celsius.

The heater 122 is disposed within the nonconductive substrate 112 and is provided to maintain the soot sensor 110 within the desired temperature range. In particular, heater 122 generates heat in response to a signal received from the microprocessor 16. In one exemplary embodiment, the heater 122 maintains the nonconductive substrate 112 within a temperature range of 100-500 degrees Celsius when detecting an amount of soot on the soot sensor 110. The heater 122 can also periodically increase the temperature of the soot sensor 110 to at least 550 degrees Celsius to burn off the collected soot on the soot sensor 110. In one exemplary embodiment, the heater 122 is a metal trace disposed on the nonconductive substrate 112.

In an alternative embodiment of soot sensing system 10, when the soot sensor 110 is utilized instead of the soot sensor 12, the measuring circuit 14 is provided to measure an electrical parameter between the electrodes 114, 116 of the soot sensor 110 that is indicative of an amount of soot deposited on the sensor 110. In one exemplary embodiment, the electrical parameter is a resistivity level between the electrodes 114, 116. Further, the measuring circuit 14 is electrically coupled to the electrodes 114, 116 of the soot sensor 110, via the conductive lines 70, 72, respectively.

A brief explanation of a process for manufacturing the soot sensor 110 will now be provided. Initially, the deposition machine 210 can dispose electrodes 114, 116 circumferentially around the nonconductive substrate 112. Next, the deposition machine 210 can dispose protective layers 118, 120 on the electrodes 114, 116 circumferentially around the nonconductive substrate 112.

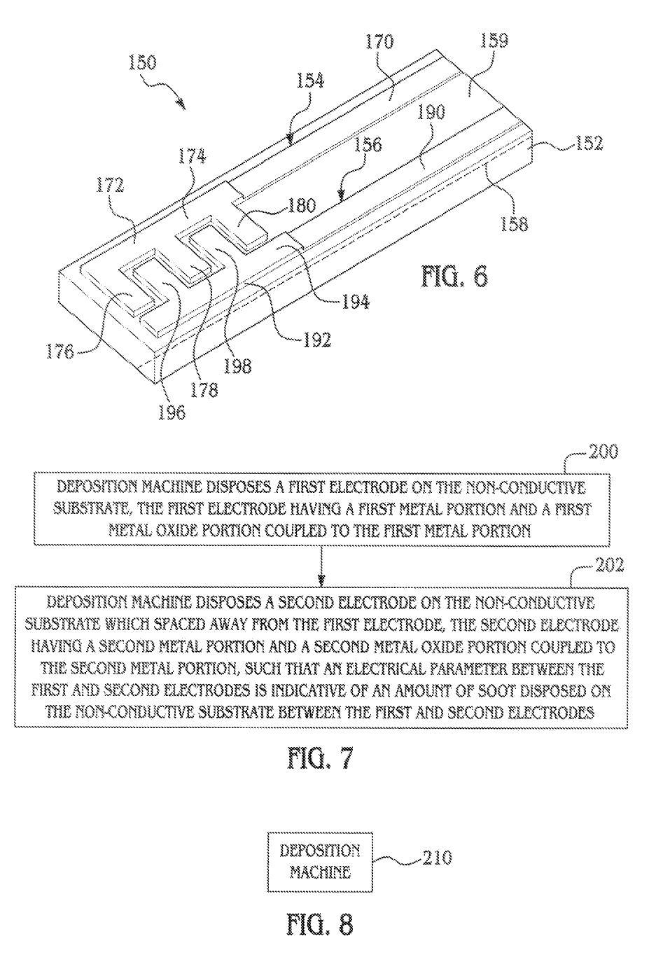

Referring to FIG. 6, a soot sensor 150 that can be utilized in the soot sensing system 10, instead of the soot sensor 12, will now be explained. The soot sensor 150 is provided to detect an amount of soot in an exhaust stream communicating with the soot sensor 150. The soot sensor 150 includes a nonconductive substrate 152, electrodes 154, 156, and a heater 158.

The soot sensor 150 is provided to detect an amount of soot in an exhaust stream communicating with the soot sensor 150. The soot sensor 150 includes a nonconductive substrate 152, electrodes 154, 156, and a heater 158.

The nonconductive substrate 152 has a generally rectangular shape. Of course in alternative embodiments, the nonconductive substrate 152 could have alternate shapes known to those skilled in the art. The nonconductive substrate 152 is constructed from an electrically nonconductive material. For example, in one exemplary embodiment the nonconductive substrate 152 is constructed from alumina. Of course in alternative embodiments, the nonconductive substrate 152 could be constructed from other electrically nonconductive materials known to those skilled in the art.

The electrode 154 is disposed on a surface 159 of the nonconductive substrate 152. The electrode 154 includes a metal portion 170 and a metal oxide portion 172 that is electrically coupled to the metal portion 170. The metal portion 170 has a generally rectangular shape extending longitudinally along the nonconductive substrate 152. The metal oxide portion 172 includes a body portion 174 and finger portions 176, 178, 180. The body portion 174 is electrically coupled to an end of the metal portion 170. The finger portions 176, 178, 180 are generally rectangular shaped and extend from the body portion 174 generally parallel to one another and spaced apart from one another.

The electrode 156 is disposed on the surface 159 of the nonconductive substrate 152 and is spaced apart front the electrode 154. The electrode 156 includes a metal portion 190 and a metal oxide portion 192 that is electrically coupled to the metal portion 190. The metal portion 190 has a generally rectangular shape extending longitudinally along the nonconductive substrate 152. The metal oxide portion 192 includes a body portion 194 and finger portions 196, 198. The body portion 194 is electrically coupled to an end the metal portion 190. The finger portions 196, 198 are generally rectangular shaped and extend from the body portion 194 generally parallel to one another and spaced apart from one another. The finger portions 176, 178, 180 of the electrode 154 are interdigitated with the finger portions 196, 198 of the electrode 156.

It should be noted that an electrical parameter between the electrodes 154, 156 can be utilized to determine an amount of soot that has been deposited on the soot sensor 150, which is further indicative of an amount of soot in an exhaust stream communicating with the sensor 150. In one exemplary embodiment, the electrical parameter between the electrodes 154, 156 that is utilized to determine an amount of soot deposited on the sensor 150 is a resistivity level between the electrodes 154, 156. It should be noted that when soot is deposited between the electrodes 154, 156, a relatively high resistance electrical short is obtained between the electrodes 154, 156. Thus, as additional soot is deposited on the sensor 150, a resistivity level between the electrodes 154, 156 is reduced. Accordingly, the resistivity level between the electrodes 154, 156 can be utilized to calculate the amount of soot that has been deposited on the sensor 150. Of course, in alternative embodiments other electrical parameters could be utilized to determine the amount of soot deposited on the sensor 150, such as conductivity level or a capacitance level between the electrodes 154, 156 for example.

The heater 158 is disposed within the nonconductive substrate 152 and is provided to maintain the soot sensor 150 within the desired temperature range. In particular, the heater 158 generates heat in response to a signal received from the microprocessor 16. In one exemplary embodiment, the heater 158 maintains the nonconductive substrate 152 within a temperature range of 100-500 degrees Celsius. when detecting an amount of soot on the soot sensor 150. The heater 158 can also periodically increase the temperature of the soot sensor 150 to at least 550 degrees Celsius to burn off the collected soot on the soot sensor 150. In one exemplary embodiment, the heater 158 is a metal trace disposed on the nonconductive substrate 152.

In an alternative embodiment of soot sensing system 10, when the soot sensor 150 is utilized instead of the soot sensor 12, the measuring circuit 14 is provided to measure an electrical parameter between the electrodes 154, 156 of the soot sensor 150 that is indicative of an amount of soot deposited on the sensor 150. In one exemplary embodiment, the electrical parameter is a resistivity level between the electrodes 154, 156. Further, the measuring circuit 14 is electrically coupled to the electrodes 154, 156 of the soot sensor 150, via the conductive lines 70, 72, respectively.

Referring to FIG. 7, a method for manufacturing the soot sensor 150 will now be explained.

At process step 200, the deposition machine 210 disposes the electrode 154 on the nonconductive substrate 152. The electrode 154 has the metal portion 170 and a metal oxide portion 172 coupled to the metal portion 170.

At process step 202, the deposition machine 210 disposes the electrode 156 on the non-conductive substrate 152 which spaced away from the electrode 154. The electrode 156 has the metal portion 190 and the metal oxide portion 192 coupled to the metal portion 190, such that an electrical parameter between the electrodes 154, 156 is indicative of an amount of soot disposed on the non-conductive substrate 152 between the electrodes 154, 156.

The soot sensing system and soot sensors described herein provide a substantial advantage over other systems and methods. In particular, the soot sensors provide a technical effect of protecting sensing electrodes thereon by either covering the electrodes with a protective layer, or utilizing electrodes having a metal oxide portion that are less likely to be eroded away from the soot sensor by exhaust gases impinging on the soot sensor.

While the invention has been described with reference to exemplary embodiments, it will be understood by those skilled in the art that various changes may be made and equivalent elements may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another. Further, the use of the terms a, an, etc. do not denote a limitation of quantity, but rather denote the presence of at least one of the referenced item.

What is claimed is:

1. A soot sensor, comprising:
a non-conductive substrate;
a first electrode disposed on the non-conductive substrate;
a second electrode disposed on the non-conductive substrate and spaced away from the first electrode;
a first protective layer disposed over at least a portion of the first electrode; and
a second protective layer disposed over at least a portion of the second electrode, such that an electrical parameter between the first and second electrodes is indicative of an amount of soot disposed on the non-conductive substrate between the first and second electrodes.

2. The soot sensor of claim 1, wherein the non-conductive substrate is an alumina layer.

3. The soot sensor of claim 1, wherein the first protective layer comprises at least one of a zirconia layer and a silicon carbide layer.

4. The soot sensor of claim 1, wherein the electrical parameter comprises a resistivity level or a conductivity level.

5. The soot sensor of claim 1, further comprising a heater disposed in the non-conductive substrate configured to maintain the non-conductive substrate within a temperature range of 100-500 degrees Celsius.

6. The soot sensor of claim 1, wherein the first electrode has a first plurality of finger portions, and the second electrode has a second plurality of finger portions, the first plurality of finger portions being interdigitated with the second plurality of finger portions.

7. The soot sensor of claim 1, wherein the first protective layer is disposed around the outer periphery of the non-conductive substrate over the first electrode.

8. The soot sensor of claim 7, wherein the second protective layer is disposed around the outer periphery of the non-conductive substrate over the second electrode.

9. The soot sensor of claim 1, wherein the first electrode is a platinum electrode.

10. A soot sensing system, comprising:
a soot sensor having a non-conductive substrate, first and second electrodes, and first and second protective layer layers, the first electrode being disposed on the non-conductive substrate, the second electrode being disposed on the non-conductive substrate and spaced away from the first electrode, the first protective layer being disposed over at least a portion of the first electrode, the second protective layer being disposed over at least a portion of the second electrode, such that an electrical parameter between the first and second electrodes is indicative of an amount of soot disposed on the non-conductive substrate between the first and second electrodes; and
a measuring circuit electrically coupled to the first and second electrodes, the measuring circuit configured to generate a signal indicative of the electrical parameter and further indicative of the amount of soot disposed on the non-conductive substrate between the first and second electrodes.

11. The soot sensing system of claim 10, further comprising a microprocessor configured to receive the signal from the measuring circuit and to determine an electrical parameter value indicative of the amount of soot based on the signal, the microprocessor further configured to store the electrical parameter value in a memory device.

12. A method for manufacturing a soot sensor, comprising:
disposing a first electrode on a non-conductive substrate;
disposing a second electrode on the non-conductive substrate and spaced away from the first electrode;
disposing a first protective layer over at least a portion of the first electrode; and
disposing a second protective layer over at least a portion of the second electrode, such that an electrical parameter between the first and second electrodes is indicative of an amount of soot disposed on the non-conductive substrate between the first and second electrodes.

13. A soot sensor, comprising:
a non-conductive substrate;
a first electrode disposed on the non-conductive substrate, the first electrode having a first metal portion and a first metal oxide portion coupled to the first metal portion; and
a second electrode disposed on the non-conductive substrate and spaced away from the first electrode, the second electrode having a second metal portion and a second metal oxide portion coupled to the second metal portion, such that an electrical parameter between the first and second electrodes is indicative of an amount of soot disposed on the non-conductive substrate between the first and second electrodes.

14. The soot sensor of claim 13, wherein the first metal oxide portion of the first electrode comprises first plurality of finger portions, and the second metal oxide portion of the second electrode comprises a second plurality of finger portions, the first plurality of finger portions being interdigitated with the second plurality of finger portions.

15. The soot sensor of claim 13, wherein the first metal portion is a platinum portion.

16. The soot sensor of claim 13, wherein the first metal oxide portion is a zirconia portion.

17. A soot sensing system, comprising:
a soot sensor having a non-conductive substrate and first and second electrodes, the first electrode disposed on the non-conductive substrate, the first electrode having a first metal portion and a first metal oxide portion coupled to the first metal portion, the second electrode disposed on the non-conductive substrate and spaced away from the first electrode, the second electrode having a second metal portion and a second metal oxide portion coupled to the second metal portion, such that an electrical parameter between the first and second electrodes is indicative of an amount of soot disposed on the non-conductive substrate between the first and second electrodes; and
a measuring circuit electrically coupled to the first and second electrodes, the measuring circuit configured to generate a signal indicative of the electrical parameter and further indicative of the amount of soot disposed on the non-conductive substrate between the first and second electrodes.

18. The soot sensing system of claim 17, further comprising a microprocessor configured to receive the signal from the measuring circuit and to determine an electrical parameter value indicative of the amount of soot based on the signal, the microprocessor further configured to store the electrical parameter value in a memory device.

19. A method for manufacturing a soot sensor, comprising:
disposing first electrode on the non-conductive substrate, the first electrode having a first metal portion and a first metal oxide portion coupled to the first metal portion; and
disposing a second electrode on the non-conductive substrate and spaced away from the first electrode, the second electrode having a second metal portion and a second metal oxide portion coupled to the second metal portion, such that an electrical parameter between the first and second electrodes is indicative of an amount of soot disposed on the non-conductive substrate between the first and second electrodes.
